(19) United States
(12) Patent Application Publication
(10) Pub. No.: US 2016/0290404 A1
(43) Pub. Date: Oct. 6, 2016

(54) PACKAGING DEVICE FOR ROLLING ELEMENT BEARINGS

(71) Applicant: AKTIEBOLAGET SKF, Göteborg (SE)

(72) Inventor: Hans Wendeberg, Västra Frölunda (SE)

(73) Assignee: Aktiebolaget SKF, Goteborg (SE)

(21) Appl. No.: 15/034,353

(22) PCT Filed: Oct. 20, 2014
(86) PCT No.: PCT/SE2014/051231

§ 371 Date: May 4, 2016

(30) Foreign Application Priority Data
Nov. 6, 2013 (SE) 1300690-3

(51) Int. Cl. F16C 41/04; B65D 81/18; B65D 85/02

(52) U.S. Cl. CPC F16C 41/04; B65D 85/02; B65D 81/18; F16C 2300/14; F16C 2226/14

(57) ABSTRACT

The present invention relates to a packaging device for transportation and handling of a rolling element bearing that provides a base member, a cover member, and side members connected to the base member and to the cover member. The base member, cover member and side members form an enclosing space for accommodating the rolling bearing. The packaging device is arranged to contain the rolling bearing during induction heating of the rolling bearing with an induction heater comprising a coil. The present invention also relates to the use of a packaging device for induction heating of a rolling element bearing, and to a method for manufacturing a packaging device for a rolling element bearing.

### FIELD OF THE INVENTION

The present invention relates transportation, handling and mounting of rolling bearings. More specifically, the present invention relates to a packaging device for transportation and handling of a rolling bearing, which packaging device comprises a base member, a cover member, and side members forming an enclosing space for accommodating the rolling bearing. The present invention also relates to the use of a packaging device for transportation and handling of a rolling bearing, and to a method for manufacturing a packaging device for transportation and handling of a rolling bearing.

### BACKGROUND ART

A critical step in the lifecycle of a rolling element bearing is the mounting of the bearing in an intended application, for example, the mounting of the bearing to a shaft. If the bearing is not mounted in a correct manner, the bearing may be damaged which may lead to reduced service lifetime or premature failing of the bearing. A known mounting technique involves heating the bearing using an induction heater in order to expand the bearing inner ring and to obtain an interference fit on the shaft as the bearing cools.

Prior to mounting by using induction heating, the bearing is often transported and handled in a packaging device for encapsulating and protecting the bearing. Before starting the mounting steps using induction heating, the bearing is removed from the packaging device and lifted or installed to a induction heating device comprising a magnetic coil or magnetic core member which is arranged through the bore of the inner ring of the bearing. This involves risk of bearing damage related to the handling of the bearing, contamination of the bearing, as well as extra handling steps that are time consuming

### SUMMARY OF THE INVENTION

In view of the above-mentioned and other drawbacks of the prior art, a general object of the present invention is to provide an improved packaging device for transportation and handling of a rolling bearing, improved use of a packaging device for transportation and handling of a rolling bearing, and to an method for manufacturing an improved packaging device for transportation and handling of a rolling bearing.

Another object is to provide a packaging device, and use thereof, which facilitates the mounting of bearing using induction heating by reducing the handling time and the risk for damage of the bearing. Still another object is to allow for more efficient heating of the bearing during the induction heating process.

These and other objects are met by the subject matters provided in the independent claims. Preferred embodiments of the invention are presented in the dependent claims.

According to a first aspect thereof, the present invention relates to a packaging device for transportation and handling of a rolling element bearing, which packaging device comprises a base member, a cover member, and side members connected to the base member and to the cover member, wherein the base member, cover member and side members form an enclosing space for accommodating the rolling bearing. Furthermore, the packaging device is arranged to contain the rolling bearing during induction heating of the rolling bearing with an induction heater comprising a coil.

The invention is based on the realization by the inventors that the mounting of a bearing using induction heating may be considerably improved and facilitated by providing a packaging device which is configured to be used in cooperation with the operative elements of an induction heater, thereby allowing the bearing to remain in the packaging device during the heating process. By allowing the rolling bearing to remain in the packaging device during heating in an induction heater, the high risk handling step of removing the bearing from the packaging device and arranging the bearing the induction heater is removed. Instead, the bearing may remain in a protective and secure position inside the packaging device while the packaging device including the rolling bearing may be installed in the induction heater. Furthermore, during the heating process, the heat generated in the induced short circuits formed in the conductive material of the rolling bearing is to a larger extent contained in the close proximity of the rolling bearing inside the packaging device. In other words, the packaging device insulates the bearing, and more efficient heating with lower heat loss from heat radiation and convection from the rolling bearing, is achieved. Thereby, the heating of the bearing may be performed with increased control and accuracy. Also, by allowing for retaining of the rolling bearing in the packaging device during induction heating, the bearing is less exposed during handling and there is a reduced risk for contamination of the rolling bearing.

In more detail, the packaging device may be configured to allow for the introduction of a coil and/or a core member of an induction heater into the packaging device in order to produce an alternating magnetic field inducing short circuit currents in the bearing, which currents heats the bearing components, such as the inner ring. During the induction heating process, the induced current flows mainly at the surface of the bearing material as a result of the skin effect and the magnetic coupling. Therefore, the ring surface heats up more quickly than the inside of the ring.

The packaging device is particularly advantageous for cooperation with an induction heater for heating a large rolling bearing, such as a large self-aligning roller bearing. A large rolling bearing is a bearing having an external diameter of 500 mm or more. For example, a limit for the misalignment of a spherical roller bearing using conventional technology is 1.5 [deg.].

According to an exemplifying embodiment, the base member comprises a sealed first opening, which first opening is openable for insertion of a coil and/or a core member of the induction heater into the enclosing space and into a bore of the rolling bearing. Thereby, the bearing may be transported to the mounting site in a protective and safe manner enclosed in the packaging device, wherein the packaging device protects the bearing from damage and contamination. At the mounting site, the first sealed opening which is arranged to the opened may be opened such that the packaging device including the bearing may be mounted in an induction heater, wherein the coil or core member of the magnetic circuit of the induction heater may be inserted into the packaging device and into the bore of the inner ring of the bearing.

According to an exemplifying embodiment, the packaging device further comprises a support structure arranged to support a set of rolling elements and/or an inner ring of the rolling bearing. The support structure advantageously allows for the correct position of the rolling elements and/or the inner ring in relation to the outer ring of the bearing, such that locking or damaging of the rolling elements or the raceways of the inner and/or outer rings due to faster heating and expansion of the inner ring in relation to the outer ring during the heating process, may be reduced or prevented.

According to an exemplifying embodiment, the support structure is arranged to hold the set of rolling elements and/or the inner ring in an axially raised position. For example, for a spherical or toroidal bearing laying down with an axial side resting on and/or being supported by base member, the rolling elements and/or the inner ring is arranged to be elevated by the support structure from the base plate. Thereby, the rolling elements and/or inner ring may be held by the support structure in a relative position in relation to the outer ring, such that faster heating and expansion of the inner ring during the induction heating proves does not lead to the damaging or locking of the bearing. For example, for a spherical bearing, the set of rolling elements may be lifted to an axially center position in relation to the bearing geometry, or to a position providing sufficient play between each rolling element and the inner and outer raceways.

According to an exemplifying embodiment, the support structure is arranged to hold the set of rolling elements in an axially raised position in relation to an outer ring of the rolling bearing.

According to an exemplifying embodiment, the cover member comprises a sealed second opening, which second opening is openable for insertion of a coil and/or a core member of the induction heater into the enclosing space and into a bore of the rolling bearing. Thereby, the coil and/or core member of the induction heater may be inserted into the packaging device through the cover member. The packaging device may e.g. comprise only the first sealed opening arranged in the base member, or only the second sealed opening arranged in the cover member. The packaging device may also comprise both the first and second sealed opening which when open allow for that the coil and/or core member of the induction heater may be fully arranged through the packaging device via two different openings. Furthermore, the first and/or second openings may advantageously be aligned with an axial center of the rolling bearing. In more detail, via the first and second openings, the coil and/or core members forming part of a magnetic circuit of the induction heater may advantageously be arranged through the packaging device from base member to cover member, and through the inner ring bore of the rolling bearing inside the packaging device, such that a suitable magnetic circuit may be formed for efficiently channel the magnetic field in the close proximity of the rolling bearing inside the packaging device.

In other words, as is clear from the above, the packaging device may according to various embodiments comprise a sealed and openable first opening arranged in the base member, and/or a sealed and openable second opening arranged in the cover member, which first and/or second sealed opening being openable for insertion of a coil and/or a core member.

According to an exemplifying embodiment, the packaging device further comprises a sealing device for holding a corrosion inhibitor, wherein the rolling bearing is enclosed in sealing device. Thereby, a corrosion inhibitor may advantageously be retained to protect the bearing both during transport and during the heating process. For example, the sealing device may be formed of a sealed bag of tight material for holding a liquid based corrosion inhibitor, such as Vapor Phase Inhibitor (VPI). By allowing the bearing to remain in the sealing device during heating with induction heater, evaporation of corrosion inhibitor due to the heating of the bearing may advantageously be reduced or prevented.

According to an exemplifying embodiment, the sealing device is arranged to enable insertion of the coil and/or core member of the induction heater into the bore of the rolling bearing. For example, the sealing device may have a toroidal shape, with square or circular cross-section, adapted to the form of the bearing, such that the coil and/or core member may be place through the center hole of the sealing device. According to an alternative embodiment, the sealing device is provided with a sealed third opening, which third opening is openable for insertion of the coil and/or core member of an induction heater into the sealing device and into the bore of the rolling bearing. For example, the opening in the sealing device may opened by removing a piece of the sealing device by cutting or tearing, e.g. along a predefined slit or indentation in the sealing device.

According to a further aspect thereof, the present invention relates to the use of a packaging device according to any of one the above described embodiments, for heating a rolling bearing which is placed in the packaging device. The use of the packaging device further comprises placing the packaging device containing the rolling bearing in operative cooperation with an induction heater comprising a coil and/or core member, and arranging the coil and/or core member into the enclosing space of the packaging device and into the bore of the inner ring of the rolling bearing.

According to an exemplifying embodiment, the base member of the packaging device comprises a sealed first opening, wherein the use of the packaging device further comprises opening the first opening of the packaging device, and inserting the coil and/or coil member into the first opening.

According to a further exemplifying embodiment, the base member of the packaging device comprises a sealed second opening, wherein the use of the packaging device further comprises opening the second opening of the packaging device, and inserting the coil and/or coil member into the second opening.

According to a further aspect thereof, the present invention relates to a method for manufacturing a packaging device for transportation and handling of a rolling element bearing, the method comprising providing a base member, cover member and side members, and forming an enclosing space of the base member, cover member and side members, which enclosing space is arranged to accommodate the rolling bearing. Furthermore, the method comprises arranging the packaging device for accommodating the rolling bearing during heating of the rolling bearing with an induction heater comprising a coil and/or core member which is inserted into the enclosing space and into an inner ring bore of the rolling bearing.

The method provides an improved packaging device for transportation, handling, and heating a rolling bearing with an induction heater, and is advantageous in similar manners as described in relation to the first aspect of the present invention.

According to an exemplifying embodiment of the method, it further comprises providing the base member of the packaging device with a sealed first opening, which first opening is openable for insertion of the coil and/or core member of the induction heater into the enclosing space and into the inner ring bore of the rolling bearing.

According to an exemplifying embodiment of the method, it further comprises providing the cover member of the packaging device with a sealed second opening, which second opening is openable for insertion of the coil and/or core member into the enclosing space and into the inner ring bore of the rolling bearing.

In other words, the method may comprise providing the base member of the packaging device with a sealed first opening and/or providing the cover member of the packaging device with a sealed second opening, which openings being openable for insertion of the coil and/or core member.

According to an exemplifying embodiment of the method, it further comprises providing the packaging device with an support structure inside the enclosing space, which support structure is arranged to locate the set of rolling elements and/or the inner ring of the rolling bearing in an axially central position in relation to the outer ring during heating of the rolling bearing with the induction heater. Thereby, locking of the rolling elements of the rolling bearing, such as rollers, between the inner and outer rings, potentially damaging the rolling elements and raceways of the inner and/or outer rings, may advantageously be reduced or avoided.

According to various exemplifying embodiments, by being openable the sealed first and/or second opening can be opened, for example by removing a removable sealing member. The sealing member may also be formed of a removable or hinged hatch. The first opening may further be closeable such that the opening may be sealed again after finalizing of the induction heating process. For example, the first removable sealing member may be reattached to the first opening by means of a sealing member provided with stick-on or adhesive material, allowing for simple removal of the sealing member, for example by hand. In other word, the sealing member is arranged to be hand operated. The stick-on material may further allow for reattachment of the sealing member after the heating process. The sealing member may also be covering the first and/or second opening by attachment means arranged snap-on fit attachment of the sealing member, i.e. designed to snap into position and fit tightly.

Generally, other objectives, features, and advantages of the present invention will appear from the following detailed disclosure, from the attached dependent claims as well as from the drawings are equally possible within the scope of the invention.

### BRIEF DESCRIPTION OF DRAWINGS

Embodiments of the invention will now be described, by way of example, with reference to the accompanying drawings, wherein:

FIG. 1 is a schematic perspective view of an exemplifying embodiment of the packaging device according to the present invention.

FIG. 2 is a schematic perspective view of an exemplifying embodiment of the packaging device according to the present invention.

FIG. 3 is a schematic perspective view of an exemplifying embodiment of the packaging device according to the present invention, wherein the packaging device contains a rolling bearing.

FIG. 4 is a schematic perspective view of an exemplifying embodiment of the packaging device according to the present invention, wherein the packaging device contains a rolling bearing.

FIG. 5 is a schematic cross-sectional view of an embodiment of an arrangement comprising a packaging device containing a rolling bearing and an induction heater, according to the present invention.

FIG. 6 is a schematic cross-sectional view of an embodiment of an arrangement comprising a packaging device containing a rolling bearing and an induction heater, according to the present invention.

FIG. 7 is a partial schematic cross-sectional view of an embodiment of an arrangement comprising a packaging device containing a rolling bearing, and core members of a magnetic circuit of an induction.

FIG. 8 is a schematic cross-sectional view of an exemplifying embodiment of the packaging device according to the present invention.

FIG. 9a is a schematic perspective view of an exemplifying embodiment of the packaging device according to the present invention.

FIG. 9b is a schematic perspective view of an exemplifying embodiment of the packaging device according to the present invention.

FIG. 10 is a schematic cross-sectional view of an exemplifying embodiment of the packaging device according to the present invention.

FIG. 11 is a schematic cross-sectional view of an exemplifying embodiment of the packaging device according to the present invention.

FIG. 12 is a schematic cross-sectional view of an exemplifying embodiment of the packaging device according to the present invention.

It should be understood that the drawings are not true to scale and, as is readily appreciated by a person skilled in the art, dimensions other than those illustrated in the drawings are equally possible within the scope of the invention.

### DETAILED DESCRIPTION OF EMBODIMENTS OF THE INVENTION

In the drawings, similar, or equal elements are referred to by equal reference numerals.

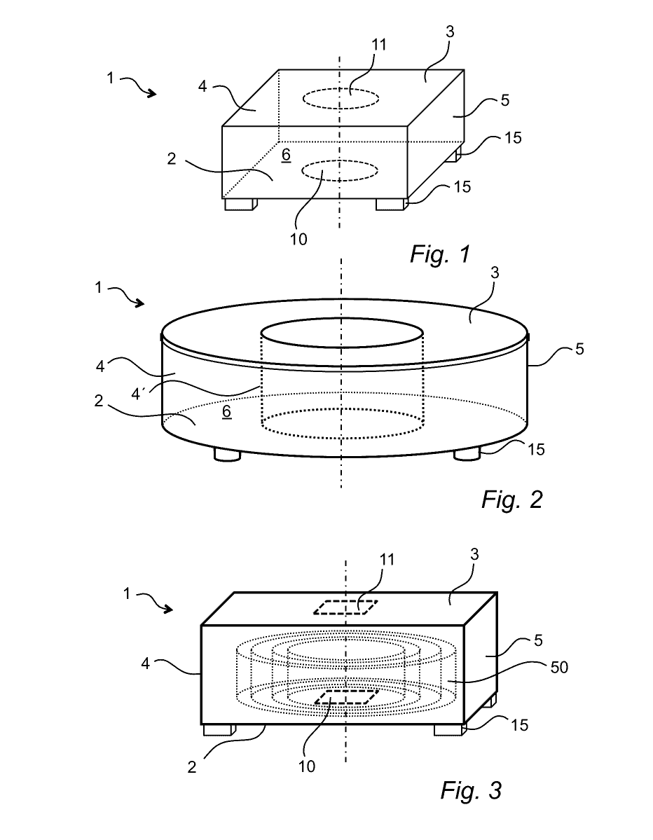

In FIG. 1, a schematic perspective view of an exemplifying embodiment of the packaging device 1 according to the present invention is shown. The packaging device 1 is formed of a heat resistant material, and comprises a base member 2 forming the bottom of the packaging device 1 upon which the bearing is arranged to rest, a cover member 3 forming the upper lid of the packaging device 1, and side members 4 and 5 connecting the base member 2 and cover member 3, such that enclosing space 6 for accommodating the rolling bearing is provided. As further shown, the base member 2 is provided with a sealed first opening 10, which is openable for insertion of a coil and/or a core member of an induction heater into the enclosing space 6. The packaging device further comprises a sealed second opening 11 arranged in the cover member 3. Also, the second opening 11 is openable for insertion of the coil and/or a core member of the induction heater into the enclosing space 6. The first and second sealed openings 10 and 11 are axially aligned along a vertical central axis of the packaging device 1, indicated by a dash-dot line in FIG. 1. The packaging device is further equipped with feet 15 arranged under the base member 2, in the corners thereof, which feet are arranged to facilitate lifting of the packaging device by e.g. hand, with lifting forks, or by lifting straps. The sealed openings 10 and 11 are circular and have a shape and dimension adapted to an induction heater having a cylinder formed coil and/or core member.

As illustrated, the packaging device 1 may be provided with the sealed first opening 10 and the sealed second opening 11. However, the packaging device may also be provide with only the sealed first opening 10, or only the sealed second opening 11. Hence, the packaging device 1 may be provided with the sealed first opening 10 and/or the sealed second opening 11.

In FIG. 2 a schematic perspective view of an alternative embodiment of the packaging device 1, is shown. The packaging device 1 is arranged in a similar manner as described in relation to FIG. 1, unless stated or depicted otherwise. The body of the packaging device 1 has a toroid shape with a square cross-section. This allows for insertion of the coil and/or core member directly through the center opening of the packaging device, along dash-dot line indicating the vertical axial center of the packaging device 1. The center opening is not sealed. As further shown, the base member 2 and cover member 3 have a circular geometry with center openings. Side members 4 and 5 are formed by the same continuous circular body having a cylindrical shape. Also inner side member 4′ has a cylindrical shape and limits the accommodating space 6 in the radial inner direction towards to center opening.

In FIG. 3, a schematic perspective view of an exemplifying embodiment of the packaging device 1 is shown. The packaging device 1 is arranged in a similar manner as described in relation to FIG. 1, unless stated or depicted otherwise. As shown, the packaging device 1 contains a rolling bearing 50. The sealed first and second openings 10 and 11 are square-shaped and aligned with the vertical center axis of the packaging device 1 and the axis of the rolling bearing 50, indicated by the dash-dot line. The bearing 50 is lying down on an axial side on the base member 2.

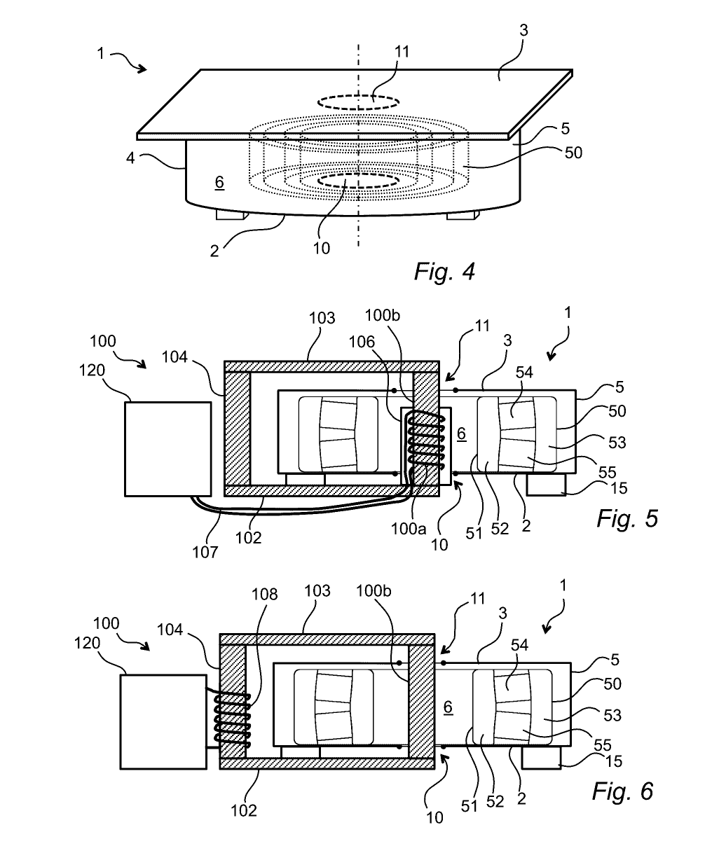

In FIG. 4, a schematic perspective view of an alternative embodiment of the packaging device 1 is illustrated. The base member 2, the cylinder-shaped side members 4 and 5, and square-shaped cover member 3 delimits the accommodating space. Round sealed openings 10 and 11 are provided in the base member 2 and cover member 3, as shown.

In FIGS. 5 and 6 schematic cross-sectional views of two alternative embodiments of an arrangement comprising a packaging device 1 containing a rolling bearing 50 and an induction heater 100, are illustrated. The induction heater 100 comprises a control cabinet 120 for controlling a coil and magnetic circuit formed of interconnected core members 100b, 102, 103, and 104. For example, core members 100b, 102 and 104 are attached to each other to form an open integral U-shaped core section, wherein the upper core member 103 has been positioned across the open upper ends of core members 100b and 104 to complete the magnetic circuit after the packaging device 1 including the bearing 50 has been arranged in position for heating. As shown, core member 100b passes through the packaging device via opened openings 10 and 11, and through the inner bore 51 of bearing 50. The bearing 50 further comprises an inner ring 52 a rolling elements 54 and 55 formed of rollers arranged in two rows, and an outer ring 53. The rollers are arranged between an inner raceway of the inner ring 52 and an outer raceway of the outer ring 53.

With reference to FIG. 5, the induction heater coil 100a and part of the core member 100b are build into a casing 106 which is inserted into accommodating space 6 of the packaging device 1. Coil 100a is connected to the control cabinet 120 via cables 107.

With reference to FIG. 6, the induction heater coil 108 is arranged outside the packaging device 1, and generates a magnetic field which is channeled by the core members to the bearing inside the packaging device 1 in an efficient manner

One, two, or a plurality of coils may be coupled to the magnetic core and used to heat the bearing inside the packaging device 1. In order to control the heating process, temperature probes being connected to the control cabinet may be coupled to the bearing elements in order to measure the temperature of e.g. the inner ring. For large bearing, heating time may be 15-30 minutes, depending of the operating conditions and power output. Also, magnetic coupling and bearing material, among other things, will influence the efficiency and performance of the system.

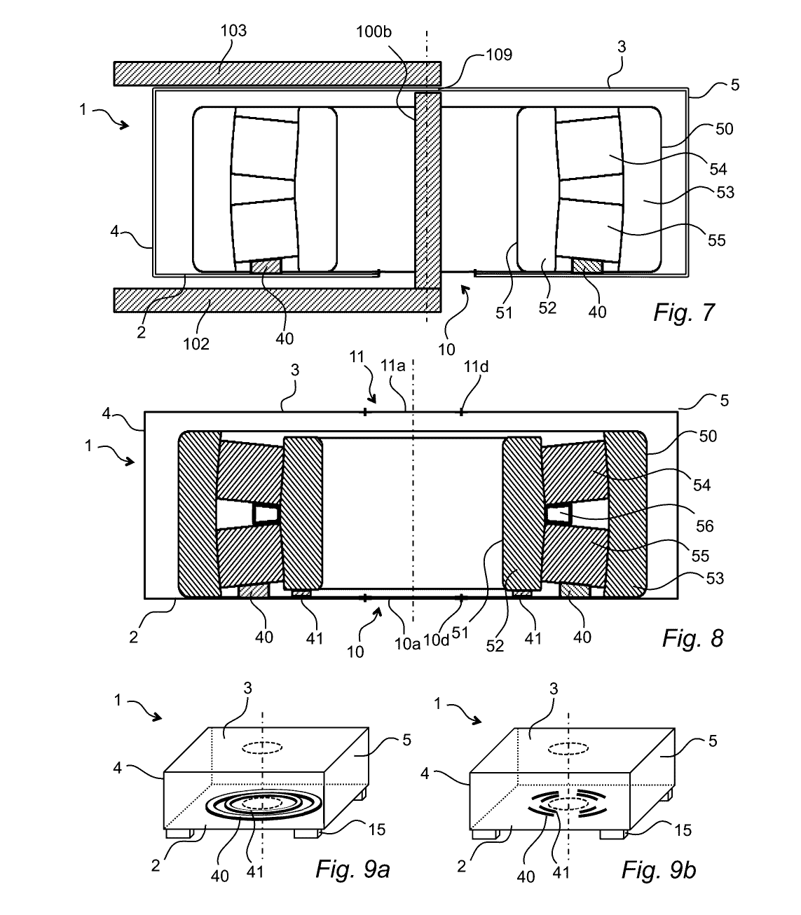

In FIG. 7, a partial schematic cross-sectional view of an embodiment of an arrangement comprising a packaging device 1 containing a double row spherical roller bearing 50, and core members 100b, 102, and 103 forming part of the magnetic circuit. As shown, support structures 40 are provided to support the set of rolling elements, such that they are held in a suitable position for transportation and during the heating process. The axial sides of both the inner ring 52 and the outer 53 are in abutment with the base member 2, while the support structure 40 extends upward from the base member 2, in between the inner and outer rings 52 and 53. Thereby, the support structure 40 uplift the set of rolling elements from their otherwise lower position with no radial play between the raceways and roller-contacting-surface, into a position with more radial play. This prevents locking and damaging of the rolling elements 54 and 55 or the raceways of the inner and/or outer rings 52 and 53 during induction heating involving faster heating and expansion of the inner ring in relation to the outer ring during the heating process.

As further shown, the core members of the magnetic circuit of the induction heater is only inserted into the packaging device via the first opening 10 in the base member 2. The cover member 3 is not provided with an opening. Instead, the magnetic circuit is partially interrupted, and a gap 109 is formed between the upper end of core member 100b and core member 103, wherein the magnetic field is channeled through the cover member 3.

According to an alternative embodiment, the complete cover member 3 of the packaging device 1 may be removed before installing the packaging device 1 in the induction heater and inserting the core member 100b into the bore 51 of the bearing via opening 10.

According to yet an alternative embodiment, the core members of the magnetic circuit of the induction heater is only inserted into the packaging device via the second opening in the cover member, and the base member is not provided with an opening. Instead, the magnetic circuit is partially interrupted and a gap is formed between the core members, wherein the magnetic field is channeled through the base member.

The axial relative position between the rolling elements in the two rows may be obtained by means of a cage (not shown), or guide ring (not shown).

In FIG. 8, a schematic cross-sectional view of an exemplifying embodiment of the packaging device 1 is shown. In this embodiment, the geometry of the self-aligning bearing 50 differs in that the axial width of the inner ring 52 is less than the axial width of the outer ring 53. In order to arrange the inner ring in a correct position and to reduce the risk of locking and damaging of the raceways and rolling elements 54 and 55 during the heating process, the support structures further comprises support member 41 which is arranged to hold the inner ring 52 in an axially raised position in relation to the base member 2. For example, the inner ring 52 may be raised to an axially centered position in relation to the outer ring 53, as shown. As further illustrated, the bearing 50 comprises a guide ring 56 which transfers the lifting support function of the support member 40 from the axially lower row of rolling elements 55 to the axially upper row of rolling elements 54. Thereby, both rows of rolling elements 54 and 55 may be arranged in an axially raised position with more roller-to-raceway play which is suitable for transportation and heating, rather than hanging in position in which the gravitational pull forces the rolling elements into a tight position between the spherical raceways of the inner and outer rings 52 and 53.

As further shown in FIG. 8, the sealed first and second openings 10 and 11 are sealed with a respective sealing member 10a and 11a. Sealing member 10a is secured in position by means of attachment means 10d. Sealing member 11a is secured in position by means of attachment means 11d.

In FIG. 9a, the packaging device 1 comprising the support members 40 and 41 are shown in a perspective view. Each ring-formed support member 40 and 41 is arranged on the base member 2 and extends axially upwards and encircle the center axis indicated with a dash-dot line. The support member 40 and 41 may be formed by non-conductive, or low-conductive, material, in order to prevent heating of the support member during induction heating.

Alternatively, as shown in FIG. 9b, the support members 40 and 41 may according to an exemplifying embodiment, be formed into circle segments. The support members 40 and 41 may also be proved with gaps for inserting straps or other means for lifting the bearing out of from the packaging device 1.

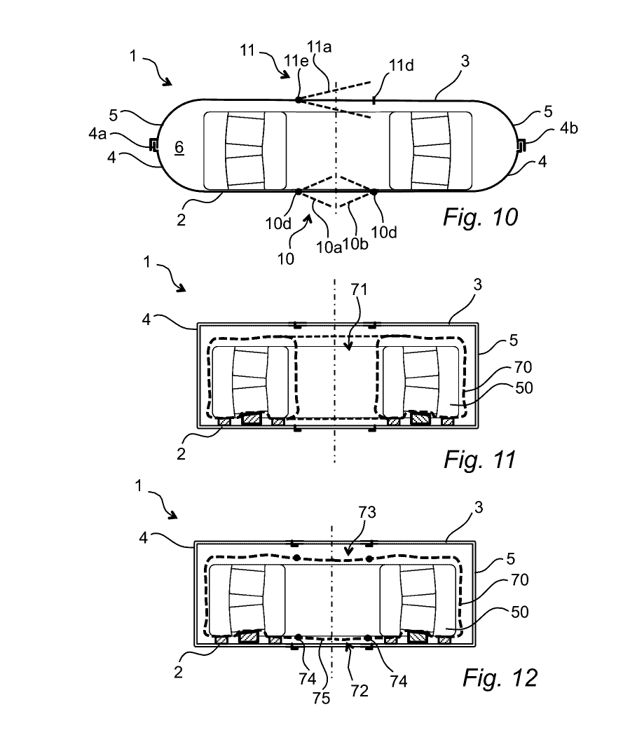

In FIG. 10, a schematic cross-sectional view of an exemplifying embodiment of the packaging device according to the present invention is shown. As illustrated, the side members 4 and 5 are integrally formed with the base member 2 and cover member 3, respectively. In more detail, the base member 2 has rounded edges with bend upward to form a part of the side members 4. Likewise, the cover member 3 has rounded edges which bend downward to form part of he side members 5. The partial side members 4 and 5 are connected which attachments means 4a and 4b to form the accommodating space 6.

With reference to FIG. 10, two alternative embodiments of the sealed openings of the packaging device 1 are depicted. The first sealed opening 10 comprises two sealing members 10a and 10b, which may be opening by pivoting movement via a respective pivot member 10d. The sealing members 10a and 10b may be arranged to pivot inwards or outwards in relation to the accommodating space 6. The second sealed opening 11 comprises sealing member 11a is releasable attached at one edge to the cover member 3 by attachment means 11d, and at an opposite edge by a pivot means 11e, such as a hinge element, or a film hinge.

In FIGS. 11 and 12, schematic cross-sectional views of exemplifying embodiments of the packaging device 1 are shown, further comprising a sealing device 70 for holding a corrosion inhibitor, wherein the rolling bearing 50 is enclosed in sealing device. The sealing device 70 is arranged to enable insertion of the coil and/or core member of the induction heater into the bore of the rolling bearing 50 during the heating process. The sealing device may be formed of plastic film or similar material, and be sufficiently non-pervious to liquid formed corrosion inhibitors, such as VPI type corrosion inhibitors.

With reference to FIG. 11, the sealing device 70 has toroidal shape with a center hole allowing for direct insertion of the coil and/core members of the induction heater after removal of the sealing members sealing the first and second openings 10 and 11.

With reference to FIG. 12, the sealing device is provided with a sealed third opening 72, which third opening is openable for insertion of the coil and/or core member of an induction heater into the sealing device and into the bore of the large rolling bearing 50. For example, a portion 75 of the sealing device 70 may be cut or removed along a predefined slit or indentation 74.

It should be noted that the invention has mainly been described above with reference to a few embodiments. However, as is readily appreciated by a person skilled in the art, other embodiments than the ones disclosed above are equally possible within the scope of the invention, as defined by the appended patent claims.

For example, even though the packaging device has been mainly described in relation to a configuration in which a rolling bearing is lying down with is center axis in a vertical position, the packaging device, bearing and induction heater may also be arranged with the center axis in a horizontal alignment. Also, features and advantages described in relation to the first sealed opening may also be attributed the second sealed opening in a corresponding manner, and vice versa.

In the claims, the word “comprising” does not exclude other elements or steps, and the indefinite article “a” or “an” does not exclude a plurality. A single apparatus or other unit may fulfill the functions of several items recited in the claims. The mere fact that certain features or method steps are recited in mutually different dependent claims does not indicate that a combination of these features or steps cannot be used to advantage.

1. A packaging device for transportation and handling of a rolling element bearing, the device comprises:
a base member,
a cover member, and
side members connected to the base member and to the cover member, wherein the base member, cover member and side members form an enclosing space for accommodating the rolling element bearing, and wherein
the packaging device is arranged to contain the rolling element bearing during induction heating of the rolling bearing with an induction heater having a coil.

2. The packaging device according to claim 1, wherein the base member further comprises a sealed first opening that is openable for insertion of at least one of a coil (100a) and a core member of the induction heater into the enclosing space and into a bore of the rolling element bearing.

3. The packaging device according to claim 2, further comprising a support structure arranged to support at least one of a set of rolling elements and an inner ring of the rolling element bearing.

4. The packaging device according to claim 3, wherein the support structure is arranged to hold at least one of the set of rolling elements and the inner ring in an axially raised position.

5. The packaging device according to claim 3, wherein the support structure is arranged to hold the set of rolling elements in an axially raised position in relation to an outer ring of the rolling element bearing.

6. The packaging device according to claim 1, wherein the cover member provides a sealed second opening that is openable for insertion of at least one of a coil (100a) and a core member of the induction heater into the enclosing space and into a bore of the rolling element bearing.

7. The packaging device according to claim 1, further comprising a sealing device for holding a corrosion inhibitor, wherein the rolling element bearing is enclosed in the sealing device.

8. The packaging device according to claim 7, wherein the sealing device is arranged to enable insertion of at least one of the coil and core member of the induction heater into the bore of the rolling element bearing.

9. The packaging device according to claim 8, wherein the sealing device is provided with a sealed third opening that is openable for insertion of at least one of the coil and the core member of an induction heater into the sealing device and into the bore of the rolling element bearing.

10. A method of using a packaging device for heating a rolling element bearing that is placed in the packaging device, the method comprising:
placing the packaging device containing the rolling element bearing in operative cooperation with an induction heater having at least one of a coil and a core member,
arranging at least one of the coil and the core member into the enclosing space of the packaging device and into the bore of the inner ring of the rolling element bearing.

11. The method of using a packaging device according to claim 10, wherein the base member of the packaging device provides a sealed opening, the method further comprising:
opening the sealed opening of the packaging device, and
inserting at least one of the coil and coil member into the opening.

12. A method for manufacturing a packaging device for transportation and handling of a rolling element bearing, comprising:
providing a base member, cover member and side members,
forming an enclosing space of the base member, cover member and side members, wherein the enclosing space is arranged to accommodate the rolling element bearing, and
arranging the packaging device for accommodating the rolling element bearing during heating of the rolling bearing with an induction heater including at least one of a coil and a core member that is inserted into the enclosing space and into an inner ring bore of the rolling element bearing.

13. The method for manufacturing a packaging device according to claim 12, further comprising providing the base member of the packaging device with a sealed first opening that is openable for insertion of at least one of the coil and core member of the induction heater into the enclosing space and into the inner ring bore of the rolling element bearing (50).

14. The method for manufacturing a packaging device according to claim 12, further comprising providing the cover member of the packaging device with a sealed second opening that is openable for insertion of at least one of the coil and core member into the enclosing space and into the inner ring bore of the rolling element bearing.

15. The method for manufacturing a packaging device according to claim 12, further comprising
providing the packaging device with a support structure inside the enclosing space, wherein the support structure is arranged to locate at least one of the set of rolling elements and the inner ring of the rolling element bearing in an axially central position in relation to the outer ring during heating of the rolling element bearing with the induction heater.
